(19) United States
(12) Patent Application Publication
(10) Pub. No.: US 2010/0250470 A1
(43) Pub. Date: Sep. 30, 2010

(54) LIFESTYLE DISEASE PREVENTION APPARATUS AND LIFESTYLE DISEASE PREVENTION METHOD

(75) Inventor: Keiichiro Takahashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/724,008

(22) Filed: Mar. 15, 2010

(30) Foreign Application Priority Data
Mar. 26, 2009 (JP) 2009-075728

(51) Int. Cl. G06N 5/02; G06F 3/00

(52) U.S. Cl. 706/11; 706/54

(57) ABSTRACT

There is provided a lifestyle disease prevention apparatus capable of objectively recognizing physical condition of a test subject. The apparatus includes: a biological information storing unit in which biological information of the test subject in connection with test subject identification information which identifies the test subject is stored in advance; and a risk calculating unit which reads the biological information in connection with the selected test subject identification information from the biological information storing unit and calculates a lifestyle disease probability that the test subject belongs to a progress stage of each disease targeted for prevention and/or improvement which is preset on the basis of the read biological information.

### BACKGROUND OF THE INVENTION

1. Field of the Invention

The present invention relates to a lifestyle disease prevention apparatus for supporting lifestyle disease prevention.

Priority is claimed on Japanese Patent Application No. 2009-075728, filed on Mar. 26, 2009, the content of which is incorporated herein by reference.

2. Description of the Related Art

A system for supporting lifestyle disease prevention, for example, is disclosed in Japanese Patent No. 3823192 and Japanese Patent No. 4034741 in the related art.

Still, it is necessary to sufficiently motivate and support a test subject to continuously make improvements to their lifestyle for the purpose of lifestyle disease prevention. However, it is necessary to improve one's lifestyle from a young age for lifestyle disease prevention, but since it takes a long time for a lifestyle disease to reach a serious state, it is difficult to be sufficiently careful regarding the disease while in a healthy or non-diseased state. Further, on the contrary, after reaching an advanced age, it is difficult to change one's old lifestyle.

Accordingly, in order to provide sufficient motivation and support for prevention and/or improvement of lifestyle disease, it is necessary to recognize a physical condition of a test subject.

### SUMMARY OF THE INVENTION

The invention is made in consideration of the above problems and provides a lifestyle disease prevention apparatus and a lifestyle disease prevention method for objectively recognizing a physical condition of a test subject. To this end, the present invention provides the following aspects:

(1) According to an aspect of the present invention, there is provided a lifestyle disease prevention apparatus including: a biological information storing unit in which biological information of a test subject in connection with test subject identification information which identifies the test subject is stored in advance; and a risk calculating unit, the risk calculating unit reading the biological information in connection with the selected test subject identification information from the biological information storing unit and calculating a lifestyle disease probability that the test subject belongs to a progress stage of each disease targeted for prevention and/or improvement. The progress stage is preset on the basis of the read biological information.

(2) The biological information of the test subject in the lifestyle disease prevention apparatus according to (1) may include genetic information of the test subject, and the risk calculating unit may calculate the lifestyle disease probability on the basis of the genetic information of the test subject included in the biological information of the test subject.

(3) The lifestyle disease prevention apparatus according to (1) may further include: a comment pattern storing unit in which a comment for the disease targeted for prevention and/or improvement in connection with a value of the lifestyle disease probability is stored in advance for each disease targeted for prevention and/or improvement; and a report generating unit which reads the comment corresponding to the value of the lifestyle disease probability of each disease targeted for prevention and/or improvement calculated by the risk calculating unit from the comment pattern storing unit of each disease targeted for prevention and/or improvement, and combines the read comments of each disease targeted for prevention and/or improvement to generate a report.

(4) The lifestyle disease prevention apparatus according to (1) may further include: an advice storing unit in which advice for the test subject is stored in connection with the test subject identification information; and an advice registration unit in which the advice based on the lifestyle disease probability calculated by the risk calculating unit is input, and which stores the input advice in connection with the test subject identification information in the advice storing unit.

(5) The lifestyle disease prevention apparatus according to (1) may further include: a target value storing unit in which a target value of the biological information about the test subject is stored in connection with the test subject identification information; and a target value registration unit in which the target value based on the lifestyle disease probability calculated by the risk calculating unit is input, and which stores the input target value in connection with the test subject identification information in the target value storing unit.

(6) The lifestyle disease prevention apparatus according to (1) may further include: a graph display unit which displays the lifestyle disease probability of each disease targeted for prevention and/or improvement calculated by the risk calculating unit in a graph form.

(7) In the lifestyle disease prevention apparatus according to (6), the graph display unit may display the lifestyle disease probability of each disease targeted for prevention and/or improvement calculated by the risk calculating unit in the graph form, and may display the lifestyle disease probability of each disease targeted for prevention and/or improvement in the graph form. The lifestyle disease probability is calculated on the basis of the target value of the biological information stored in the target value storing unit.

(8) The lifestyle disease prevention apparatus according to (6) further includes a changing unit which changes the value of the biological information which is the biological information read from the biological information storing unit and is used in the case where the lifestyle disease probability is calculated in the risk calculating unit, and the graph display unit may display the lifestyle disease probability of each disease targeted for prevention and/or improvement calculated by the risk calculating unit in the graph form, and may display the lifestyle disease probability of each disease targeted for prevention and/or improvement which is calculated on the basis of the value of the biological information changed by the changing unit in graph form.

(9) The lifestyle disease prevention apparatus according to (1) further includes a discrimination parameter storing unit in which a coefficient multiplied by the biological information stored in the biological information storing unit is stored in advance of each disease targeted for prevention and/or improvement, and the risk calculating unit may multiply the biological information read from the biological information storing unit by the coefficient read from the discrimination parameter storing unit to calculate a determination value of each disease targeted for prevention and/or improvement, and may calculate the lifestyle disease probability that the test subject belongs to the progress stage of each disease targeted for prevention and/or improvement on the basis of the calculated determination value of each disease targeted for prevention and/or improvement.

(10) A lifestyle disease prevention method for performing a lifestyle disease probability calculating procedure in a computer as a lifestyle disease prevention apparatus according to (1) to (9), the procedure including: reading biological information in connection with selected test subject identification information from a biological information storing unit in which the biological information of the test subject in connection with the test subject identification information which identifies the test subject is stored in advance; and calculating a lifestyle disease probability that the test subject belongs to a progress stage of each disease targeted for prevention and/or improvement. The progress stage is preset on the basis of the read biological information.

According to the aspects of the invention, the risk calculating unit reads, from the biological information storing unit in which the biological information of the test subject is stored in advance in connection with the test subject identification information for identifying the test subject, the biological information in connection with the selected test subject identification information, and calculates the lifestyle disease probability that the test subject belongs to the progress stage of each disease targeted for prevention and/or improvement. The progress stage is preset on the basis of the read biological information. Accordingly, since the lifestyle disease probability that the test subject belongs to the progress stage of each disease targeted for prevention and/or improvement can be recognized, the physical condition of the test subject can be objectively recognized.

### BRIEF DESCRIPTION OF THE DRAWINGS

FIG. 1 is a block diagram illustrating a configuration of a lifestyle disease prevention system which uses a lifestyle disease prevention apparatus according to an embodiment of the present invention;

FIG. 2 is a data configuration diagram illustrating relations of data stored in each storing unit in FIG. 1;

FIG. 3 is a data configuration diagram illustrating an example of data stored in a test subject information table TB1;

FIG. 4 is a data configuration diagram illustrating an example of data stored in a diagnosis result information table TB2;

FIG. 5 is a data configuration diagram illustrating an example of data stored in a genetic information table TB3;

FIG. 6 is a data configuration diagram illustrating an example of data stored in a physical measurement value information table TB4;

FIG. 7 is a data configuration diagram illustrating an example of data stored in a biochemical examination value information table TB5;

FIG. 8 is a data configuration diagram illustrating an example of data stored in a lifestyle information table TB6;

FIG. 9 is a diagram illustrating an exemplary procedure in which genetic information and biological information are registered in the lifestyle disease prevention apparatus in FIG. 1;

FIG. 10A is an example of a general display illustrating a graph displayed by a graph display unit in FIG. 1 and change of biological information by a changing unit;

FIG. 10B is an example illustrating specific items which illustrates a graph displayed by the graph display unit in FIG. 1, change of the biological information by the changing unit, and the graph;

FIG. 11 is a diagram illustrating an example of a method of determining whether a test subject corresponds to a specific disease by a specific disease determining unit in FIG. 1;

FIG. 12 is a diagram illustrating an example of a method of generating a report by a report generating unit in FIG. 1;

FIG. 13 is a flowchart illustrating a first operation of the lifestyle disease prevention system according to an embodiment of the invention;

FIG. 14 is a flowchart illustrating a second operation of the lifestyle disease prevention system according to an embodiment of the invention; and

FIG. 15 is a flowchart illustrating a third operation of the lifestyle disease prevention system according to an embodiment of the invention.

### DETAILED DESCRIPTION OF THE INVENTION

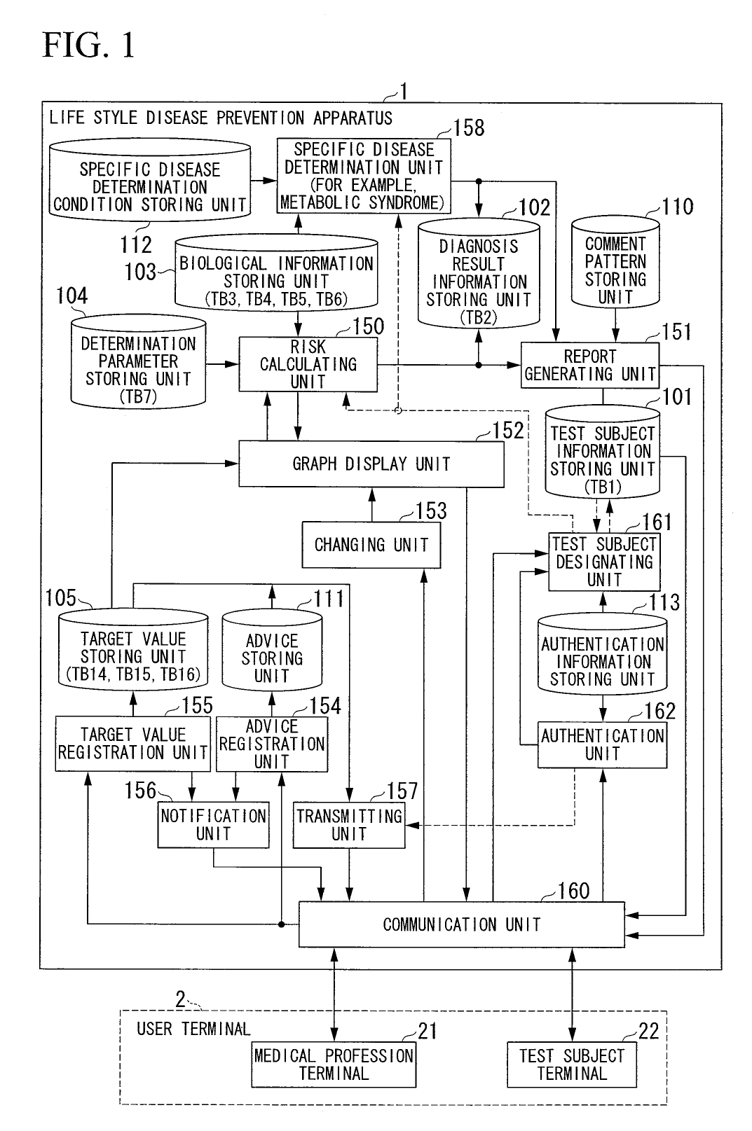

Hereinafter, embodiments according to the invention will be described with reference to the accompanying drawings. FIG. 1 is a schematic block diagram illustrating a configuration of a lifestyle disease prevention system using a lifestyle disease prevention apparatus 1 according to an embodiment of the invention.

In the lifestyle disease prevention system, the lifestyle disease prevention apparatus 1 and a user terminal 2 are connected to each other, for example, through a communication network. The communication network is a telephone network such as a public telephone network or a cellular phone network, an Internet network or an exclusive link network.

The user terminal 2 includes, for example, a medical profession terminal 21 and a test subject terminal 22. The medical profession terminal 21 is used by a medical profession such as a doctor or a counselor. Further, the test subject terminal 22 is used by a test subject who wants to manage prevention and/or improvement of his or her lifestyle disease using the lifestyle disease prevention apparatus 1. The medical profession terminal 21 and the test subject terminal 22 may both be provided in plural.

In this embodiment, the doctor or the counselor is referred to as the “medical profession” and the person who wants to manage his or her lifestyle disease prevention and/or improvement is referred to as the “test subject”. Further, the “medical profession” or the “test subject” who uses the lifestyle disease prevention apparatus 1 is referred to as a “user”.

The medical profession terminal 21 and the test subject terminal 22 include, for example, personal computers or cellular phones, respectively. An input device, a display device and the like are connected to or installed in the medical profession terminal 21 and the test subject terminal 22, respectively. Here, the input device includes a keyboard, a mouse or the like. The display apparatus includes a CRT (cathode ray tube), an LCD (Liquid Crystal Display) or the like.

Next, a configuration of the lifestyle disease prevention apparatus 1 will be described. The lifestyle disease prevention apparatus 1 includes a test subject information storing unit 101, a diagnosis result information storing unit 102, a biological information storing unit 103, a discrimination parameter storing unit 104, a target value storing unit 105, a comment pattern storing unit 110, an advice storing unit 111, a specific disease determination condition storing unit 112, and an authentication information storing unit 113.

The lifestyle disease prevention apparatus 1 further includes a risk calculating unit 150, a report generating unit 151, a graph display unit 152, a changing unit 153, an advice registration unit 154, a target value registration unit 155, a notification unit 156, a transmitting unit 157, a specific disease determination unit 158, a communication unit 160, and an authentication unit 162.

The communication unit 160 is connected to the user terminal 2 which is the medical profession terminal 21 or the test subject terminal 22 through a communication network.

The authentication unit 162 authenticates whether the user terminal 2 which transmits authentication information is a legitimate user of the lifestyle disease prevention apparatus 1 on the basis of the authentication information received from the user terminal 2 through the communication unit 160, and sets a limit so that only the legitimate users can use the lifestyle disease prevention apparatus 1.

Further, the authentication unit 162 determines whether the user terminal 2 is the medical profession terminal 21 or the test subject terminal 22. The authentication unit 162 sets a limit so that the lifestyle disease prevention apparatus 1 is used under the authority of the medical profession in the case where the user terminal 2 is the medical profession terminal 21, and sets a limit so that the lifestyle disease prevention apparatus 1 is used under the authority of the test subject in the case where the user terminal 2 is the test subject terminal 22.

For example, in the case where the user terminal 2 is the test subject terminal 22 and the lifestyle disease prevention apparatus 1 is used under the authority of the test subject, the user terminal 2 may use the lifestyle disease prevention apparatus 1 with respect to information on the test subject only as described later. However, the user terminal 2 neither presents advice nor sets a target value for preventing lifestyle diseases.

Meanwhile, in the case where the user terminal 2 is the medical profession terminal 21 and the lifestyle disease prevention apparatus 1 is used under the authority of the medical profession, the medical profession may use the lifestyle disease prevention apparatus 1 with respect only to the information of a test subject who is diagnosed or guided by the medical profession. In addition, the medical profession terminal 21 may present advice for preventing lifestyle diseases with respect to the test subject, or may set a target value in the lifestyle disease prevention apparatus 1.

Authentication information and authority information used in the above described authentication unit 162 are stored in advance in the authentication information storing unit 113. The authentication unit 162 determines, for example, whether the authentication information stored in the authentication information storing unit 113 and authentication information received from the user terminal 2 are the same, to thereby determine whether the user of the user terminal 2 is a legitimate user.

Further, in the case where it is determined that the user of the user terminal 2 is the legitimate user, the authentication unit 162 determines the authority of the user on the basis of the authority information stored in the authentication information storing unit 113.

Test subject identification information which specifies a test subject for the lifestyle disease prevention is received and input from the user terminal 2 to a test subject designating unit 161 through the communication unit 160. Here, in the case where the user terminal 2 is the test subject terminal 22, the test subject identification information specifies a user (test subject) of the test subject terminal 22. Meanwhile, in the case where the user terminal 2 is the medical profession terminal 21, the test subject identification information specifies a test subject selected from test subjects who are diagnosed or guided by the medical profession.

In the case where the user terminal 2 is the test subject terminal 22, test subject identification information of the user of the test subject terminal 22 may be included in the authentication information transmitted by the test subject terminal 22. In this case, the test subject identification information included in the authentication information may be input to the test subject designating unit 161. Accordingly, in the case where the user terminal 2 is the test subject terminal 22, the test subject who uses the test subject terminal 22 may easily input the test subject identification information to the test subject designating unit 161.

Test subject information such as an address, name, age, gender or the like of the test subject in connection with the test subject identification information which identifies the test subject is stored in advance in the test subject information storing unit 101. Further, information on a mail address of the test subject in connection with the test subject identification information may be stored in the test subject information storing unit 101.

Biological information of the test subject in connection with the test subject identification information is stored in advance in the biological information storing unit 103. The biological information of the test subject includes information about a physical measurement value, information about a biochemical examination, and information about a lifestyle. Further, the biological information of the test subject includes genetic information of the test subject.

The risk calculating unit 150 reads the biological information in connection with the target identification information, which is input to the test subject designating unit 161 through the user terminal 2, from the biological information storing unit 103. Then, the risk calculating unit 150 calculates the lifestyle disease probability that the test subject belongs to a progress stage of each disease targeted for prevention and/or improvement. The progress stage is preset on the basis of the read biological information. In addition, the risk calculating unit 150 calculates the lifestyle disease probability in which the test subject belongs to a progress stage of each disease targeted for prevention and/or improvement. The progress stage is preset on the basis of the genetic information included in the biological information of the test subject.

For example, in the discrimination parameter storing unit 104, coefficients (parameter or diagnosis parameter information to be described later) multiplied by which the biological information stored in the biological information storing unit 103 of each disease targeted for prevention and/or improvement is stored in advance. Firstly, the risk calculating unit 150 multiplies the biological information read from the biological information storing unit 103 by the coefficients read from the discrimination parameter storing unit 104 to calculate a determination value of each disease targeted for prevention and/or improvement. Then, the risk calculating unit 150 calculates the lifestyle disease probability that the test subject belongs to the progress stage of each disease targeted for prevention and/or improvement on the basis of the calculated determination value of each disease targeted for prevention and/or improvement.

In the specific disease determination condition storing unit 112, a determination condition for determining whether the test subject corresponds to a specific disease is stored in advance. The specific disease determination unit 158 reads the biological information in connection with the test subject identification information which is input to the test subject designating unit 161 from the user terminal 2, from the biological information storing unit 103, and determines whether the read biological information satisfies the determination condition which is read from the specific disease determination condition storing unit 112, to determine whether the test subject corresponds to the specific disease. The determination result of whether the test subject corresponds to the specific disease may be determined in different stages.

For example, in the specific disease determination condition storing unit 112, a metabolic syndrome is stored in advance as a specific disease to be determined. The specific disease determination unit 158 determines whether a test subject identified in the test subject identification information which is input to the test subject designating unit 161 from the user terminal 2 corresponds to the metabolic syndrome and outputs the determination result to the report generating unit 151.

The determination regarding whether the test subject belongs to the metabolic syndrome may be a determination regarding whether the test subject belongs to any one group among preset classes such as an information providing group (A), a motivational supporting group (B) or a positive supporting group (C), as described later. In this way, the preset classes may be set so that the determination result can be obtained in different stages.

In the comment pattern storing unit 110, a comment for a disease targeted for prevention and/or improvement in connection with the lifestyle disease probability value of each disease targeted for prevention and/or improvement is stored in advance of each disease targeted for prevention and/or improvement. Further, in the comment pattern storing unit 110, a comment for the disease targeted for prevention and/or improvement is stored in advance in connection with the determination result regarding whether the test subject corresponds to the metabolic syndrome.

The report generating unit 151 reads the comment corresponding to the lifestyle disease probability value of each disease targeted for prevention and/or improvement calculated by the risk calculating unit 150 from the comment pattern storing unit 110 of each disease targeted for prevention and/or improvement, and combines the read comments of each disease targeted for prevention and/or improvement to generate a report. In addition, the report generating unit 151 reads a comment corresponding to the determination result determined by the specific disease determination unit 158 from the comment pattern storing unit 110, and generates the report on the basis of the read comments.

That is, the report generating unit 151 reads the comment corresponding to the lifestyle disease probability value of each disease targeted for prevention and/or improvement calculated by the risk calculating unit 150 from the comment pattern storing unit 110, reads a comment corresponding to the determination result determined by the specific disease determination unit 158 from the comment pattern storing unit 110, and combines the read comments to generate a report. In addition, the report generating unit 151 outputs the generated report to the user terminal 2 through the communication unit 160. The report may be, for example, in a text form.

The graph display unit 152 displays the lifestyle disease probability of each disease targeted for prevention and/or improvement calculated by the risk calculating unit 150 in a graph form. Further, the graph display unit 152 displays the lifestyle disease probability of each disease targeted for prevention and/or improvement calculated by the risk calculating unit 150 in the graph form, and displays the lifestyle disease probability of each disease targeted for prevention and/or improvement which is calculated on the basis of the target value of the biological information stored in the target value storing unit 105 which will be described later in a graph form.

The changing unit 153 changes a value of the biological information which is the biological information read from the biological information storing unit 103 and is used in the case where the lifestyle disease probability is calculated by the risk calculating unit 150, on the basis of manipulation information received from the user terminal 2. The graph display unit 152 displays the lifestyle disease probability of each disease targeted for prevention and/or improvement calculated by the risk calculating unit 150 in a graph form, and displays the lifestyle disease probability of each disease targeted for prevention and/or improvement which is calculated on the basis of the value of the biological information changed by the changing unit 153 in a graph form.

In the advice storing unit 111, advice of the medical profession for the test subject is stored in connection with the test subject identification information. The advice registration unit 154 receives the advice based on the biological information read from the biological information storing unit 103 or based on the lifestyle disease probability calculated by the risk calculating unit 150, from the medical profession terminal 21, and stores the received advice in connection with the test subject identification information in the advice storing unit 111.

In the target value storing unit 105, a target value of the biological information about the test subject which is given from the medical profession is stored in connection with the test subject identification information. The target value registration unit 155 receives the target value based on the biological information read from the biological information storing unit 103, or based on the lifestyle disease probability calculated from the risk calculating unit 150, from the medical profession terminal 21, and stores the received target value in connection with the test subject identification information in the target value storing unit 105.

The advice registration unit 154 stores the advice received from the user terminal 2 which is the medical profession terminal 21 in the advice storing unit 111 only in the case where the user terminal 2 is the medical profession terminal 21 and has the authority of the medical profession. Similarly, the target value registration unit 155 stores the target value received from the user terminal 2 which is the medical profession terminal 21 in the target value storing unit 105 only in the case where the user terminal 2 is the medical profession terminal 21 and has the authority of the medical profession.

The notification unit 156 notifies, in the case where the advice registration unit 154 registers the advice in connection with the test subject identification information in the advice storing unit 111, or in the case where the target value registration unit 155 registers the target value of the biological information in connection with the test subject identification information, the test subject terminal 22 used by the test subject of information indicating that the advice is registered in the advice storing unit 111 or information indicating that the target value is registered in the target value storing unit 105, as notification information.

For example, when the notification unit 156 notifies the test subject terminal 22 which is used by the test subject of the above notification information, the notification unit 156 may read information about a mail address of the test subject in connection with the test subject identification information from the test subject information storing unit 101, and may transmit the notification information to the read mail address in a text form.

When receiving the test subject identification information from the user terminal 2, the transmitting unit 157 reads the advice stored in the advice storing unit 111 in connection with the received test subject identification information, or reads the target value stored in the target value storing unit 105 in connection with the received test subject identification information, to transmit the read advice or target value to the user terminal 2 as guidance information.

For example, in the case where the authentication unit 162 authenticates the test subject who is a legitimate user on the basis of the authentication information received from the test subject terminal 22 through the communication unit 160, the transmitting unit 157 may transmit the guidance information to the target terminal 22 used by the authenticated test subject.

In the diagnosis result information storing unit 102 is stored a diagnosis result of the test subject identified in the test subject identification information in connection with the test subject identification information. For example, the risk calculating unit 150 stores the lifestyle disease probability that the test subject belongs to the progress stage of every calculated disease targeted for prevention and/or improvement in the diagnosis result information storing unit 102 in connection with the test subject identification information. In addition, the specific disease determination unit 158 stores the determination result regarding whether the test subject corresponds to a specific disease in the diagnosis result information storing unit 102 in connection with the test subject identification information.

The diagnosis result stored in the diagnosis result information storing unit 102 may be referred to by the user terminal 2 who is authentication-processed by the authentication unit 162. In the case where the diagnosis result is referred to, the test subject using the test subject terminal 22 may refer only to his or her own diagnosis result, and the medical profession using the medical profession terminal 21 may refer only to the diagnosis result of the test subject who is diagnosed or guided by the medical profession.

Further, the biological information of the test subject stored in the biological information storing unit 103 may also be referred to by the user terminal 2 when such is authenticated by the authentication unit 162, similar to the diagnosis result stored in the diagnosis result information storing unit 102. In this case, the test subject using the test subject terminal 22 may refer only to his or her own diagnosis result, and the medical profession using the medical profession terminal 21 may refer to the diagnosis result of only the test subject who is diagnosed or guided by the medical profession.

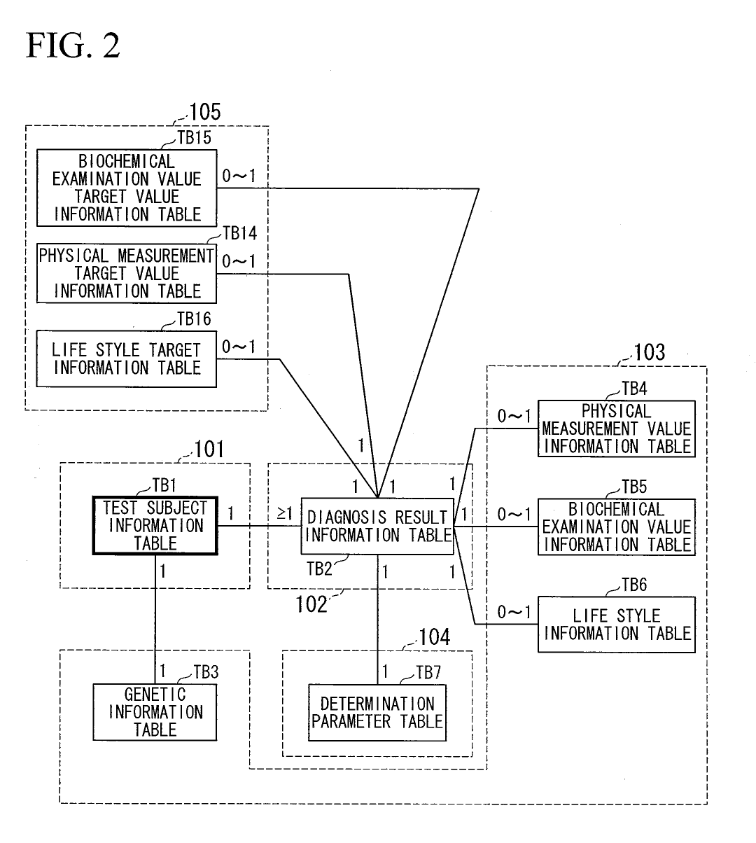

Next, an example of a data configuration including the test subject information storing unit 101, the diagnosis result information storing unit 102, the biological information storing unit 103, the determination parameter storing unit 104, and the target value storing unit 105 as described with reference to FIG. 1 will be described with reference to FIG. 2. In the following figures, like references are given in parts corresponding to the respective parts in FIG. 1, and a description thereof will be omitted.

Hereinafter, a case where “test subject information” is stored as a “test subject information table TB1” in the test subject storing unit 101, and “diagnosis result information” is stored as a “diagnosis result information table TB2” in the diagnosis result information storing unit 102 will be described.

Further, a case where “genetic information” is stored as a “genetic information table TB3”, “physical measurement value information” is stored as a “physical measurement value information table TB4”, “biochemical examination value information” is stored as a “biochemical examination value information table TB5”, and “lifestyle information” is stored as a “lifestyle information table TB6” in the biological information storing unit 103 will be described.

In addition, a case where a “physical measurement target value information table TB14”, a “biochemical examination target value information table TB15”, and a “a lifestyle target value information table TB16” are stored in the target value storing unit 105 will be described.

In the “physical measurement target value information table TB14”, the “physical measurement information” is stored in a way similar to the “physical measurement value information table TB4”. Further, in the “biochemical examination target value information table TB15”, the “biochemical examination value information” is stored in a way similar to the “biochemical examination value information table TB5”.

Moreover, in the “lifestyle target value information table TB16”, the “lifestyle information” is stored in a way similar to the “lifestyle information table TB6”.

Further, a case where a “determination parameter information table TB7” is stored in the parameter storing unit 104 will be described.

As shown in FIG. 2, in the test subject information storing unit 101, the diagnosis result information storing unit 102, the biological information storing unit 103, the determination parameter storing unit 104, and the target value storing unit 105, respective information of the “test subject information table TB1”, the “diagnosis result information table TB2”, the “genetic information table TB3”, the “physical measurement value information table TB4”, the “biochemical examination value information table TB5”, the “lifestyle information table TB6”, the “determination parameter information table TB7”, the “physical measurement value target value information table TB14”, the “biochemical examination target value information table TB15” and the “lifestyle target value information table TB16” is stored as at least one relational file using an XML (extensible markup language) database or a relational database.

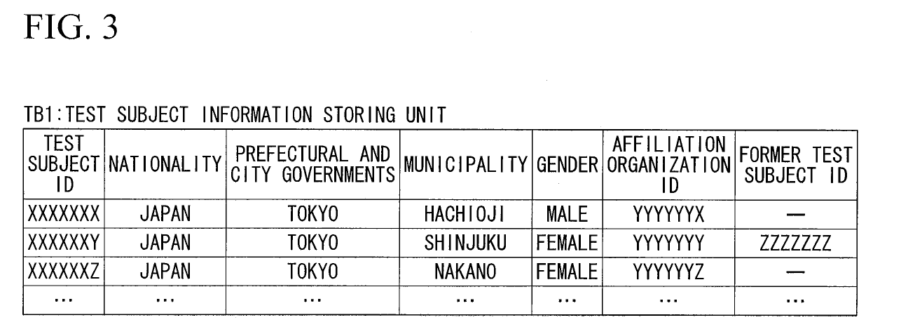

Next, information stored in each table will be described with reference to FIGS. 3 to 8.

The “test subject information” includes, for example, an information set of every test subject (test subject ID, nationality, prefectural and city governments, municipality, gender, affiliation organization ID and former test subject ID). FIG. 3 illustrates the item set and an example of item value thereof. Even in the case where an organization or local government to which the test subject belongs is changed due to moving, job changing or the like, the test subject information may be pursued by including the test subject ID and the former test subject ID.

The test subject ID is an identification code for uniquely specifying the test subject, and serves as a number for anonymizing the test subject. Further, this information may be stored as the “test subject information” to analyze data for every affiliation organization or local government of the test subject, and a health improvement management in the organization or a health formulation in the local governments is formulated by comparing other organizations or local governments therewith, to thereby provide useful information.

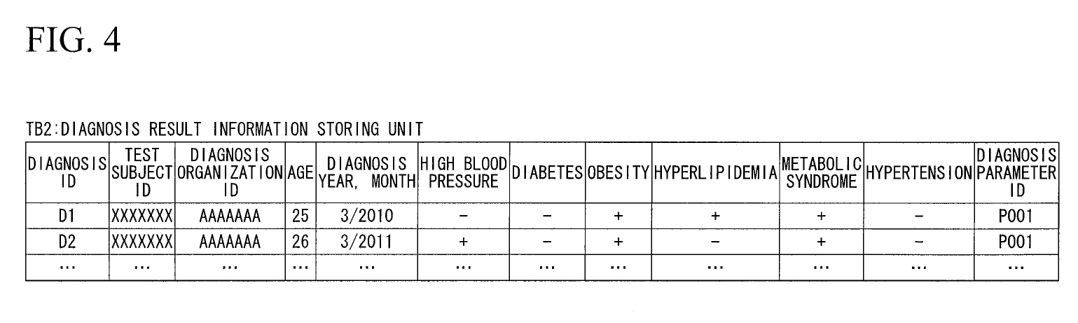

The “diagnosis result information” includes, for example, a diagnosis result and age information set for every test subject such as (an diagnosis ID, test subject ID, diagnosis organization ID, age, date, high-blood pressure stage indicator, diabetic stage indicator, metabolic syndrome stage indicator and metadata ID). Herein, the diagnosis represents a diagnosis medical operation performed by doctors and the indicator of the stage represents a “normal” or “abnormal” indicator based on the diagnosis. FIG. 4 illustrates an example of an item set of the “diagnosis result information” and item values thereof. Here, the normal class indicator is indicated as “+” and the abnormal class indicator is indicated as “−”, which represents the case that indicators of respective diseases are two types “+” and “−”. Since the test subject ID is an ID for connection with the “test subject information”, the parameter ID is an ID for connection with the “diagnosis target parameter information” used for the diagnosis.

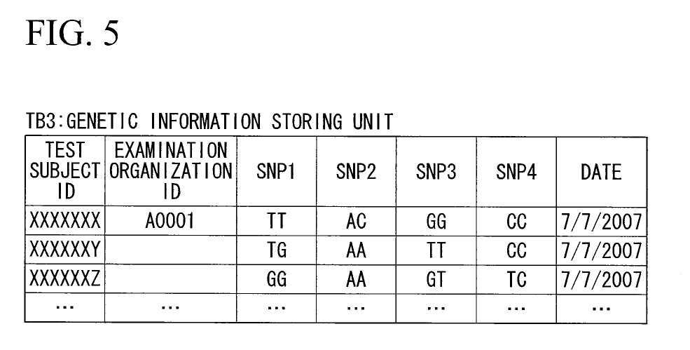

The “genetic information” includes, for example, an information set with respect to a genetic analysis (such as a test subject ID, genetic analysis organization ID, examination item values 1, . . . , examination item value n and date) which is an information set provided for every test subject. Here, the examination item value includes polymorphism information on gene including SNP, indel and microsatellite, or structural information or sequence information or the like of protein determined by the genetic polymorphism information. FIG. 5 illustrates an example of an item set of the “genetic information” and item values thereof.

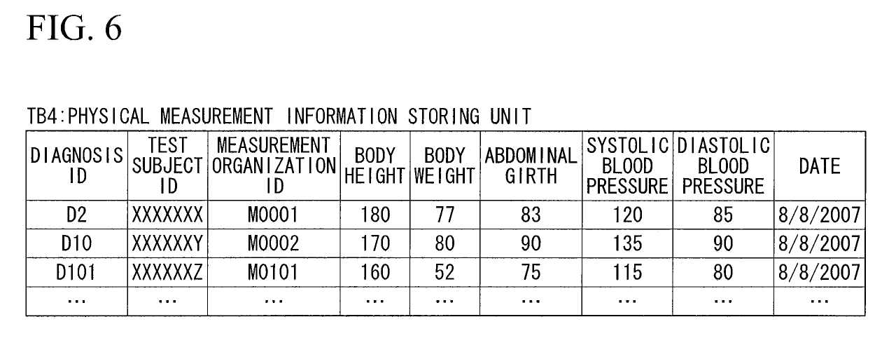

The “physical measurement value information” is a physical measurement value of the test subject who is measured, not through the biochemical examination, but by a physical examination organization or the like. For example, the physical measurement value information includes an information set of (a diagnosis ID, test subject ID, body height, body weight, BMI, systolic blood pressure, diastolic blood pressure and date). The “physical measurement value information” also includes measurement items capable of being measured at home by the test subject. FIG. 6 illustrates an example of the item set and item values thereof. The “diagnosis ID” is an ID for connection with the “diagnosis result information”. The “test subject ID” is an ID for connection with the “test subject information”.

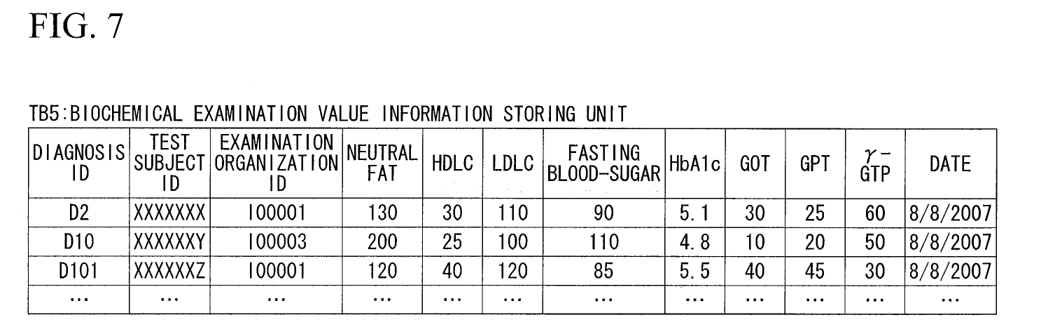

The “biochemical examination value information” is a set of biochemical analysis result values of urine or blood of the test subject examined by a physical examination organizations or the like. For example, the biochemical examination value information includes an information set of “a diagnosis ID, test subject ID, HDLC, LDLC, fasting blood-sugar level, GOT, GPT, γ-GTP and date”. FIG. 7 illustrates an example of the item set and item values thereof. The “diagnosis ID” is an ID for connection with the “diagnosis result information”, and the “test subject ID” is an ID for connection with the “test subject information”.

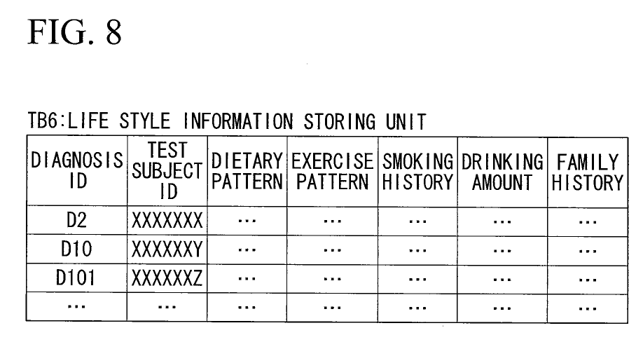

The “lifestyle information” is an information set of the test subject obtained by a questionnaire such as dietary patterns, exercise patterns, smoking history, alcohol consumption or family history (see FIG. 8).

As shown in FIGS. 3 to 8, information stored in each table is selected using the test subject identification information (test subject ID) as a key. Further, information stored in the “diagnosis result information table TB2”, the “physical measurement value information table TB4”, the “biochemical examination value information table TB5”, and the “lifestyle information table TB6” is selected using the test subject identification information (test subject ID) with the diagnosis ID as keys.

The diagnosis ID is identification information for identifying each diagnosis. In the case where a plurality of diagnoses is performed by the diagnosis ID, each diagnosis result is identified to be stored in the table and each diagnosis result may be read from the table. That is, the history of the biological information may be stored by the diagnosis ID, and the history of the biological information may be read.

Further, the information stored in the “physical measurement target value information table TB14”, the “biochemical examination target value information table TB15”, and the “lifestyle target value information table TB16” is selected using the test subject identification information (test subject ID) and the diagnosis ID as keys, in a way similar to the information stored in the “physical measurement value information table TB4”, the “biochemical examination value information table TB5”, and the “lifestyle information table TB6”.

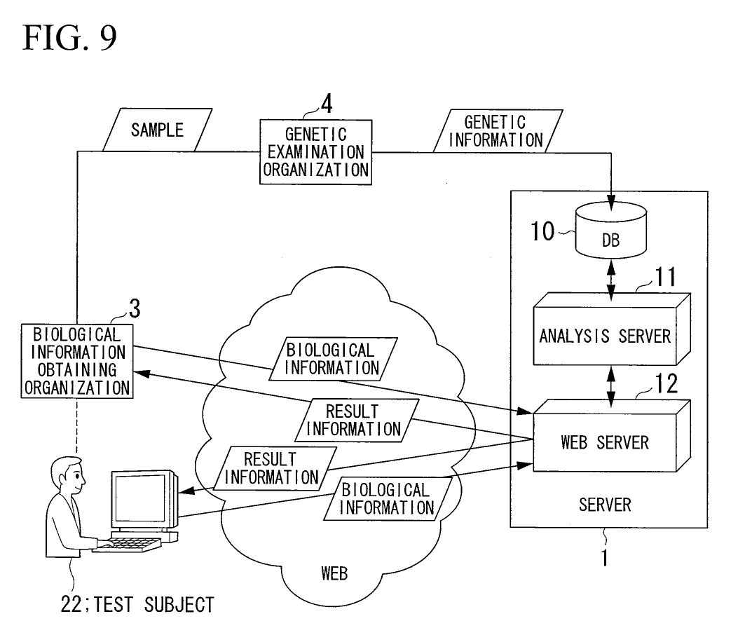

The above described “genetic information” is an analysis result of genes of the test subject analyzed by the genetic examination organization, and is registered in a database DB10 (biological information storing unit 103 in FIG. 1) included in the lifestyle disease prevention apparatus 1 by a procedure as shown in FIG. 9. Further, the biological information is also registered in the database DB10 included in the lifestyle disease prevention apparatus 1 by the procedure as shown in FIG. 9.

The database DB10 included in the lifestyle disease prevention apparatus 1 in FIG. 9 corresponds to the biological information storing unit 103 in FIG. 1. An analyzing server 11 included in the lifestyle disease prevention apparatus 1 in FIG. 9 corresponds to the risk calculating unit 150, etc. in FIG. 1. In addition, a web server 12 included in the lifestyle disease prevention apparatus 1 in FIG. 9 corresponds to the communication unit 160, etc. in FIG. 1. The lifestyle disease prevention apparatus 1 may be configured by a single server as shown in FIG. 1 and may be configured by a combination of a plurality of servers such as an analyzing server 11 and a web server 12 as shown in FIG. 9.

A biological information obtaining organization 3 in FIG. 9 is an organization which obtains blood, clinical information or the like of the test subject such as a medical organization (hospital, clinic center), company health insurance system, medical examination center or the like. Further, the genetic examination organization 4 extracts genes from samples (blood, oral cavity mucous membrane cell, nails or the like) obtained from the biological information obtaining organization 3 to transmit the analysis result to the lifestyle disease prevention apparatus 1 as the genetic information.

Next, an example of a method of obtaining biological information and genetic information and an example of a method of registering the information in the lifestyle disease prevention apparatus 1 will be described with reference to FIG. 9. Firstly, for example, an examination for the test subject is performed in the biological information obtaining organization 3 at the occasion of physical examination or the like. The biological information obtaining organization 3 transmits biological information of the test subject obtained as the examination result to the lifestyle disease prevention apparatus 1. Further, the biological information obtaining organization 3 transmits, for example, the sample obtained from the test subject in the examination, to the genetic examination organization 4. The genetic examination organization 4 performs an examination with respect to genes on the basis of the sample transmitted from the biological information obtaining organization 3 and transmits the examination result to the lifestyle disease prevention apparatus 1 as the “genetic information”.

The lifestyle disease prevention apparatus 1 registers the biological information of the test subject transmitted from the biological information obtaining organization in the biological information storing unit 103 as the “physical measurement information”, the “biochemical examination value information” or the “lifestyle information”. Further, the lifestyle disease prevention apparatus 1 registers the “genetic information” as the examination result transmitted from the genetic examination organization 4 in the biological information storing unit 103.

The “physical measurement information”, the “biochemical examination value information” and the “lifestyle information” is data examined and obtained from the biological information obtaining organization 3 such as physical examination organizations, and written as the “biological information” in FIG. 9.

### <Detailed Description of Risk Calculating Unit 150>

Next, a method of calculating the lifestyle disease probability that the test subject belongs to a progress stage of each disease targeted for prevention and/or improvement will be described. The lifestyle disease probability is calculated in the risk calculating unit 150.

If a set of a test subject ID and a diagnosis ID is input to the test subject designating unit 161, and a set of a specific test subject ID and a diagnosis ID thereof is designated, the risk calculating unit 150 obtains the “biological information” and the “genetic information” stored in advance in the biological information storing unit 103, such as “genetic information”, “physical measurement value information”, “biochemical examination information”, and “lifestyle information” as a set of the item values x=(x₁, x₂, x₃, . . . , x_{N}), as shown in FIGS. 3 to 8.

Next, on the basis of the obtained set of the item values x=(xᵢ, x₂, x₃, . . . , x_{N}), a determination value z is calculated using a discrimination function expressed in the following formula 1.

$$\begin{matrix}[ formula 1 ] & \\ z = {w}_{0} + {\sum }_{i = 1}^{N} {w}_{i} {x}_{i} & ( formula 1 )\end{matrix}$$

In this formula 1, (w₁, w₂, w₃, w_{N}) are parameters, respectively. The parameters are calculated in advance and stored in the discrimination parameter storing unit 104 as “diagnosis parameter information (coefficient)”. These parameters are calculated in advance using the Mahalanobis distance, on the basis of a known diseases group and a normal group (healthy group). Further, a qualitative variable such as a genetic type is given a dummy variable to be regarded as a quantitative variable. Accordingly, the determination value z may be calculated for the genetic type.

In addition, according to a positive or negative code of the determination value z of each disease calculated by the formula 1, it may be discerned whether the test subject corresponds to the corresponding disease, that is, whether the test subject is in a diseased state or a normal state. As described above, since the parameters using the Mahalanobis distance are used, it may be confirmed whether unknown test subject information statistically belongs to any group among the disease class and the normal class.

Next, a lifestyle disease probability p that the test subject belongs to the disease group (set of data confirmed as diseases) is calculated using a logistic function indicating the following formula 2.

[formula 2]

p=1/[1+{(1−π)/π} exp(−z)] (formula 2)

In the formula 2, π is a prior lifestyle disease probability of a disease class. In the case where a value of the prior lifestyle disease probability π of the disease class is unclear and sample groups of the disease class and the normal class are given, the value of the prior lifestyle disease probability it of the disease class is estimated in advance, according to (the number of rows in the disease group)/(the number of all the rows in the disease group and the normal group). Alternatively, the value of the prior lifestyle disease probability π of the disease class may be an integer preset as (the number of rows in the disease group)/(the number of all the rows in the disease group and the normal group).

Further, a relative risk is calculated by p/π.

In this way, the risk calculating unit 150 calculates the lifestyle disease probability p that the test subject belongs to the disease class or the relative risk p/π of each disease.

In addition, the risk calculating unit 150 calculates a total risk according to all the disease risks of the test subject by the following formulas 3 and 4.

[formula 3]

S=(Σ_{disease} relative risk)/the number of examination diseases (formula 3)

[formula 4]

(total risk)=1/(1+exp(α×(β−S)))×100 (formula 4)

In the formula 4, a coefficient α is a preset real number of a range of 2.0 to 4.0, and a coefficient β is a preset real number of a range of 1.0 to 2.0. In this respect, fixed values of a coefficient α=3 and a coefficient β=1.5 are used.

As expressed in the formula 3, the total risk is a value obtained by averaging the lifestyle disease probability p calculated of each disease by the formula 2 with respect to all the diseases, and is an average lifestyle disease probability of the diseases.

### <Detailed Description of Graph Display Unit 152 and Changing Unit 153>

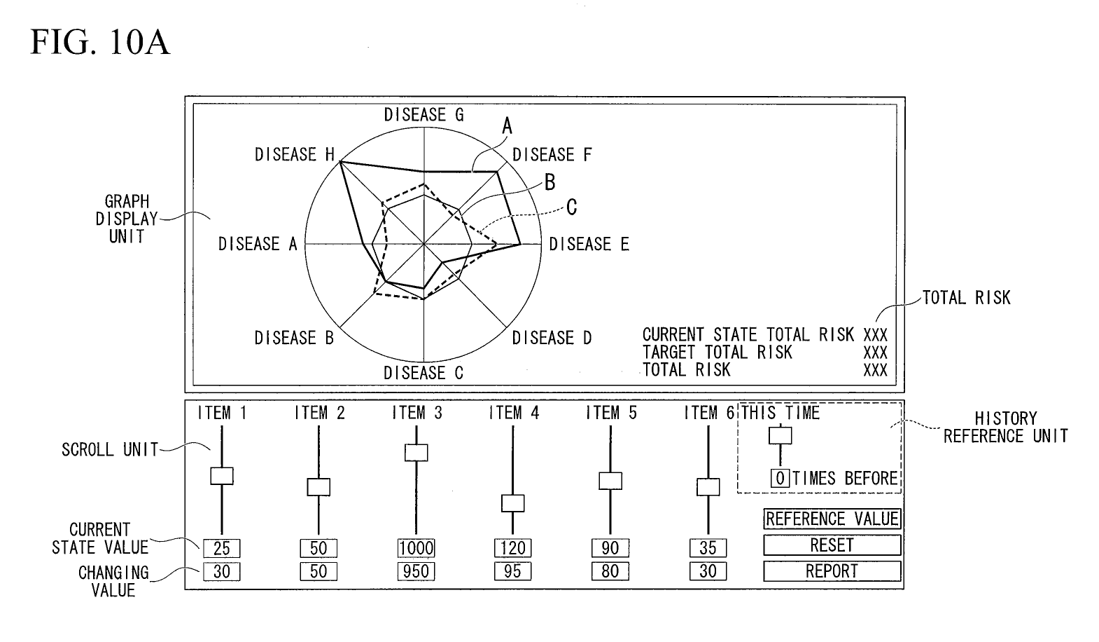

Hereinafter, a graph displayed by the graph display unit 152 and a change of biological information according to the changing unit 153 will be described with reference to FIG. 10.

The graph display unit 152 displays the lifestyle disease probability p that the test subject belongs to the disease class calculated of each disease by the risk calculating unit 150 according to the above described formulas 1 to 4, or the relative risk p/π, as a radar chart in a graph form (see graph display units in FIGS. 10A and 10B).

FIG. 10A is a general display example, and FIG. 10B shows exemplary specific items and an example of a graph thereof. In FIG. 10A, a radar chart is displayed for a plurality of diseases A to H. The diseases A to H are, for example, arteriosclerosis, hyperlipidemia, obesity, hypertension, diabetes or the like, as shown in FIG. 10B.

The graph according to the radar chart is transmitted to the user terminal 2 through the communication unit 160. The transmitted graph is displayed in the display unit of the user terminal 2 used by the user, for example, in a web format. Further, the graph display unit 152 also displays the total risk calculated by the risk calculating unit 150 in the display unit of the user terminal 2. Accordingly, the user may statistically, that is, objectively recognize the risk of each disease and the total risk.

Further, as shown in FIGS. 10A and 10B, in the display unit of the user terminal 2, a scroll unit is displayed in a lower side of the graph display unit. There is provided a scroll bar or an input form for every item of the biological information in the scroll unit, and the user may change an item value by the scroll bar or the input form.

The item value changed by the user is input to the changing unit 153 through the communication unit 160 of the lifestyle disease prevention apparatus 1 from the user terminal 2 used by the user. The changing unit 153 changes the item value for every item of the biological information on the basis of the item value input from the user terminal 2.

With respect to the item value changed by the changing unit 153, the risk calculating unit 150 re-calculates the lifestyle disease probability p or the relative risk p/π of each disease, and calculates the total risk as virtual values. The graph display unit 152 displays in the radar chart the lifestyle disease probability p or the relative risk p/π calculated as the virtual values so that differences between the virtual values and the real values can be recognized. For example, colors may be set differently, or the type of lines may be set differently to a solid line, a wavy line or the like (see a radar chart indicated by a reference C). In addition, the graph display unit 152 displays the total risk calculated as a virtual value.

In this way, the lifestyle disease prevention apparatus 1 detects the change of the item value as an event, and re-calculates the risk to generate a graph and to be displayed in the user terminal 2. The user can see the lifestyle disease probability p based on the current biological information or the relative risk p/π, and the lifestyle disease probability p or the relative risk p/π according to the virtual values, as the graph. Accordingly, the medical profession easily sets the target value for the test subject.

Further, in the case where the target value of the biological information on the test subject from the medical profession is stored in the target value storing unit 105, the risk calculating unit 150 calculates the lifestyle disease probability p or the relative risk p/π of each disease on the basis of the target value, and also calculates the total risk as the virtual value. The graph display unit 152 displays the calculated lifestyle disease probability p or relative risk p/π in the radar chart to be differentiated from other cases (see a radar chart indicated by a reference B). In addition, the graph display unit 152 displays the total risk calculated by the target value.

Moreover, if a reset button is pressed, the value set in the scroll unit returns to an initial value. The initial value is, for example, the value of the biological information of the test subject read from the biological information storing unit 103. Further, if a report button is pressed, the graph which is being displayed is downloaded to the user terminal 2. Furthermore, as the report button is pressed, the report generated by the report generating unit 151 may be downloaded to the user terminal 2.

Further, the index number of history data may be designated by a personal history reference unit. Since the biological information is stored in the biological information storing unit 103 as personal history, the index number of history data is designated by the personal history reference unit to designate the personal history of the biological information, thereby viewing the lifestyle disease probability p or the relative risk p/π as a graph. Accordingly, the user may recognize his or her biological information as personal history.

### <Detailed Description of Specific Disease Determination Unit 158>

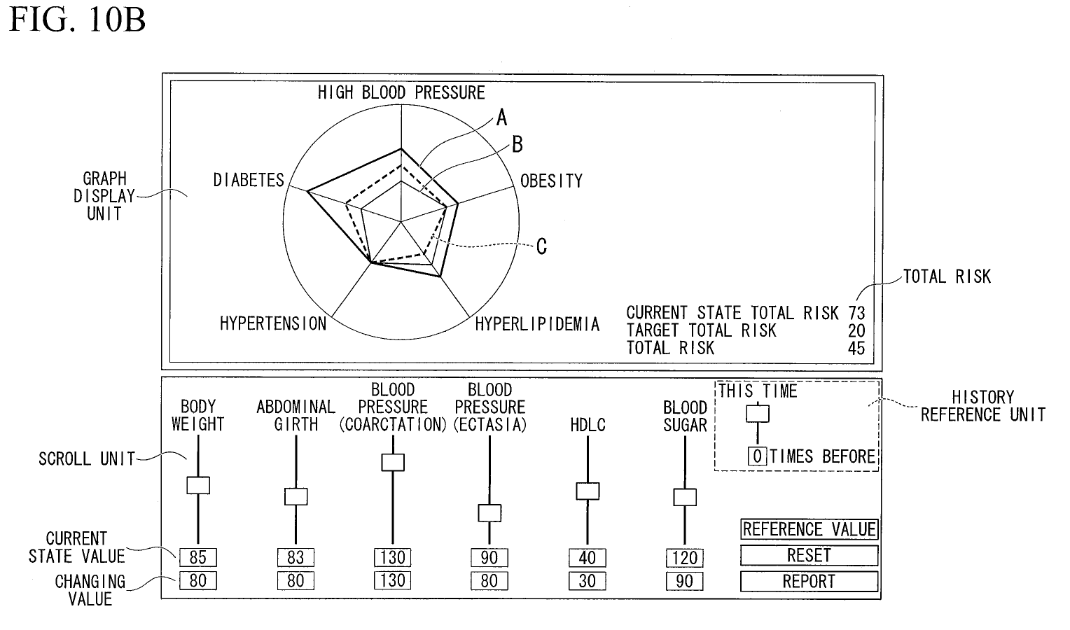

Next, a determination method of whether there is correspondence to a specific disease according to the specific disease determination unit 158 will be described with reference to an example of FIG. 11.

With respect to abdominal girth, there are two conditions.

Abdominal Girth Condition 1

The abdominal girth is equal to or more than 85 cm in male, and is equal to or more than 90 cm in female (male≧85 cm, female≧90 cm).

Abdominal Girth Condition 2

The abdominal girth is less than 85 cm in male, and is less than 90 cm and BMI is equal to or more than 25 in female (male<85 cm, female<90 cm and BMI≧25).

As a risk factor, there are four conditions.

Risk Factor Condition 1

With respect to a blood-sugar level, fasting blood-sugar level is equal to or more than 100 mg/dl, or HbAlc is equal to or more than 5.2% (fasting blood-sugar level≧100 mg/dl or HbAlc≧5.2%), or a medical treatment is being performed with respect to the blood-sugar level.

Risk Factor Condition 2

With respect to fat, neutral fat is equal to or more than 150 mg/dl, or HDL cholesterol is less than 40 mgdl (neutral fat≧150 mg/dl or HDL cholesterol<40 mgdl, or a medical treatment is being performed with respect to the fat.

Risk Factor Condition 3

With respect to blood pressure, systolic blood pressure is equal to or more than 130 mmHg, or diastolic blood pressure is equal to or more than 85 mmHg (systolic blood pressure≧130 mmHg or diastolic blood pressure≧85 mmHg), or a medical treatment is being performed with respect to the blood pressure.

Risk Factor Condition 4

There is a history of smoking.

The risk factor conditions 1 to 4 count a count value of a risk factor when satisfying the conditions. That is, the count value of the risk factor becomes any one value of 0 to 4.

On the basis of the determination results of the above described abdominal girth condition 1 and abdominal girth condition 2 and the count values of the risk factors, the test subjects are grouped into the following groups.

An information providing group (A) corresponds to the case where the count value of the risk factor is 0 when satisfying the abdominal girth condition 1 and the abdominal girth condition 2.

A motivation supporting group (B) corresponds to the case where the count value of the risk factor is 1 when satisfying the abdominal girth condition 1, or to the case where the count value of the risk factor is equal to or less than 2 when satisfying the abdominal girth condition 2.

A positive supporting group (C) corresponds to the case where the count value of the risk factor is equal to or more than 2 when satisfying the abdominal girth condition 1, or to the case where the count value of the risk factor is equal to or more than 3 when satisfying the abdominal girth condition 2.

In this way, it is grouped into any one of the information providing group (A), the motivation supporting group (B) or the positive supporting group (C).

Each condition of the abdominal girth condition 1 and the abdominal girth condition 2, and the risk factor conditions 1 to 4 corresponds to determination of a condition for determining whether the test subject corresponds to the specific disease stored in advance in the specific disease determination condition storing unit 112.

### <Detailed Description of Report Generating Unit 151>

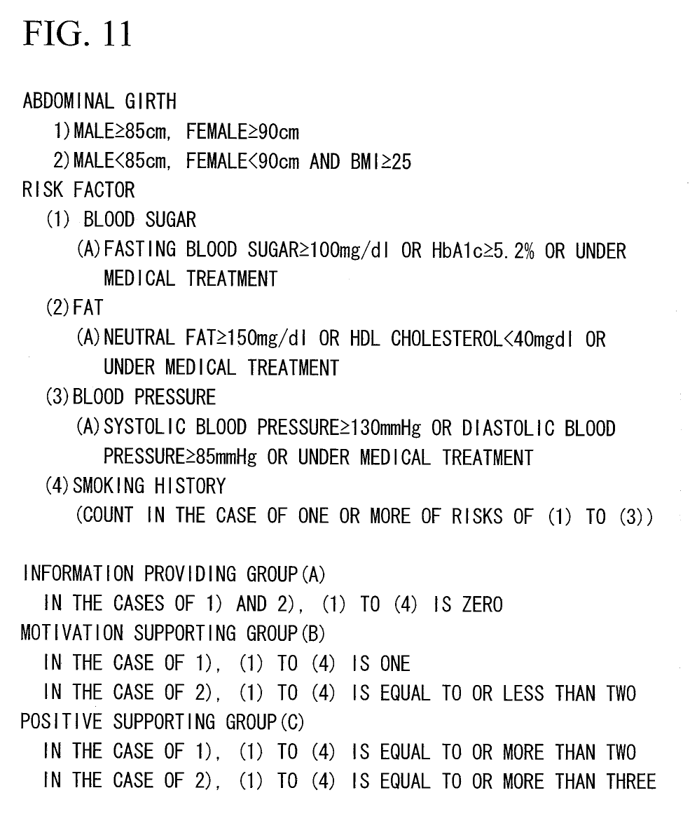

Hereinafter, a method of generating a report by the report generating unit 151 will be described with reference to FIG. 12.

For example, a diagnosis type is determined according to the determination result of the above described specific disease determination unit 158 and the risk calculating unit 150 (see a reference number 5 in FIG. 12). For example, as indicated by the reference number 5 in FIG. 12, the diagnosis type is determined as B, 11, 23, . . . , N5. Each parameter of the diagnosis type is a group classified by the specific disease determination unit 158 or information obtained by classifying the lifestyle disease probability calculated by the risk calculating unit 150.

For example, a risk lifestyle disease probability calculated of each disease is classified as a class to which the lifestyle disease probability calculated by the risk calculating unit 150 belongs, the disease risks are classified into 5-stages of less than 5%, equal to or more than 5% and less than 10%, equal to or more than 10% and less than 20%, equal to or more than 20% and less than 40%, and equal to or more than 50%.

As indicated by the reference number 1 in FIG. 12, comments or advice for each stage are stored in advance corresponding to the three classes (three stages) which are set in the specific physical examination diagnosis by the specific disease determination unit 158, in the comment pattern storing unit 110.

Further, as the reference numbers 2, 3 and 4 in FIG. 12, comments or advice are stored in advance regarding the stage to which the lifestyle disease probability calculated by the risk calculating unit 150 belongs, in the comment pattern storing unit 110.

In this way, in the comment pattern storing unit 110, the respective risk factor items (combination thereof) are staged according to the value as necessary, and comments or advice and each item (combination thereof) are stored in advance corresponding to each other. For example, in the case where type of SNP of certain disease relating genes is CC, CG and GG, comments or advice corresponding to the respective types are created as a table (see each comment or advice in FIG. 12).

It is preferable that the comments (report rules) of each table are created by a community of a doctor, health nurse, nutrition manager or counselor.

Further, the report generating unit 151 reads comments corresponding to a value of the lifestyle disease probability of each disease targeted for prevention and/or improvement calculated by the risk calculating unit 150 from the comment pattern storing unit 110, reads comments corresponding to the result determined by the specific disease determination unit 158 from the comment pattern storing unit 110, and combines the read comments to generate a report in a text form (see reference number 6 in FIG. 12).

For example, the report generating unit 151 generates a report in a text form such as “You are at risk of a lifestyle disease, . . . . There is a lifestyle disease probability you have high blood pressure, . . . . You have a high blood pressure disposition, . . . .” Further, the report generating unit 151 outputs the generated report to the user terminal 2 through the communication unit 160. For example, as described above, as the report button in FIG. 10 is pressed, the report generated by the report generating unit 151 may be downloaded to the user terminal 2.

<Operation 1: Operation in the Case where a User Calculates a Risk and Views the Risk as a Graph>

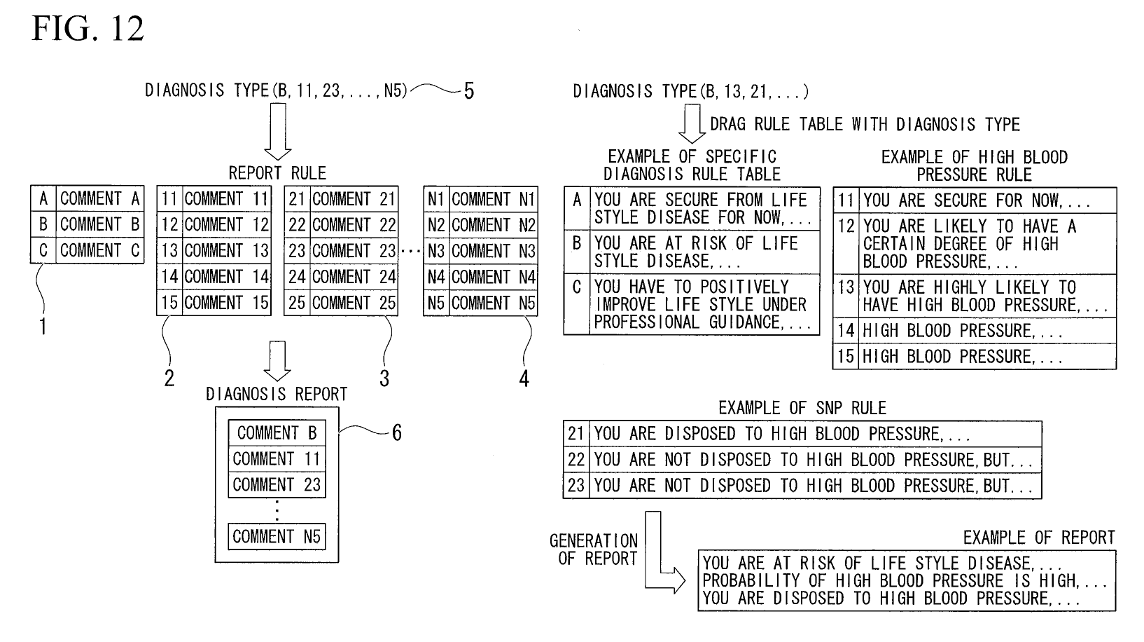

Hereinafter, an operation of the lifestyle disease prevention apparatus 1 in the case where a user calculates a risk and views the risk as a graph will be described with reference to FIG. 13. Here, the user terminal 2 is authenticated as the medical profession terminal 21 or the test subject terminal 22 by the authentication unit 162.

Firstly, the test subject identification information which specifies the test subject who performs the lifestyle disease prevention is received and input to the test subject designating unit 161 from the user terminal 2 through the communication unit 160 (step S101).

Next, the risk calculating unit 150 reads the biological information in connection with the target identification information input to the test subject designating unit 161 from the user terminal 2 from the biological information storing unit 103, and calculates the lifestyle disease probability that the test subject belongs to the progress stage for every prevention and/or improvement disease preset on the basis of the read biological information (step S102).

Next, the graph display unit 152 displays the lifestyle disease probability of each disease targeted for prevention and/or improvement calculated by the risk calculating unit 150 in a graph form (step S103).

Further, the graph display unit 152 displays the lifestyle disease probability of each disease targeted for prevention and/or improvement calculated by the risk calculating unit 150 in a graph form, and displays, in the case where a target value of the biological information in connection with the test subject identification information input to the test subject designating unit 161 is stored in the target value storing unit 105, the lifestyle disease probability of each disease targeted for prevention and/or improvement calculated on the basis of the target value of the biological information stored in the target value storing unit 105 in a graph form (step S104).

In addition, the specific disease determination unit 158 reads the biological information in connection with the test subject identification information input to the test subject designating unit 161 from the user terminal 2, from the biological information storing unit 103, and determines whether the read biological information satisfies the determination condition read from the specific disease determination condition storing unit 112 to determine whether the test subject corresponds to the specific disease (step S105).

Next, the report generating unit 151 reads the comment corresponding to the value of the lifestyle disease probability of each disease targeted for prevention and/or improvement calculated by the risk calculating unit 150, from the comment pattern storing unit 110, reads the comment corresponding to the determination result of the specific disease determination unit 158, from the comment pattern storing unit 110, and combines the read comments to generate a report (step S106).

Then, the report generating unit 151 outputs the generated report to the user terminal 2 through the communication unit 160 (step S107).

Thereafter, the user may change the value of the biological information which is read from the biological information storing unit 103 and is used in the case where the lifestyle disease probability is calculated in the risk calculating unit 150 on the basis of operation information received from the user terminal 2, using the changing unit 153 (step S108).

In the case where the user changes the value of the biological information using the changing unit 153 in step S108, the graph display unit 152 displays the lifestyle disease probability of each disease targeted for prevention and/or improvement calculated by the risk calculating unit 150 in a graph from, and displays the lifestyle disease probability of each disease targeted for prevention and/or improvement calculated on the basis of the value of the biological information changed by the changing unit 153 in a graph form (step S109).

<Operation 2: Operation in the Case where a Medical Profession Registers Advice or a Target Value>

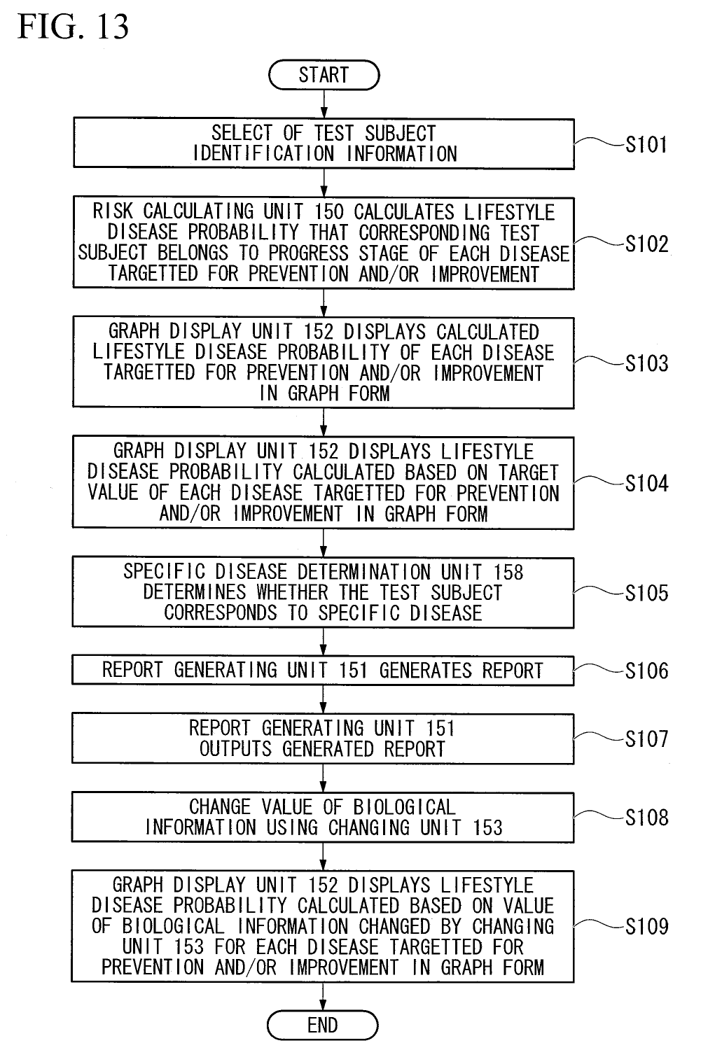

An operation of the lifestyle disease prevention apparatus 1 in the case where the medical profession registers advice or a target value will be described with reference to FIG. 14. The operation shown in FIG. 14 may be performed after the operation in FIG. 13 and may be performed independently of the operation in FIG. 13.

If the user is the medical profession, the advice or the target value may be transmitted to the lifestyle disease prevention apparatus 1 using the medical profession terminal 21 (step S201).

If the communication unit 160 of the lifestyle disease prevention apparatus 1 receives the advice from the medical profession terminal 21, the advice registration unit 154 stores the input advice in connection with the test subject identification information in the advice storing unit 111 as the advice is input from the medical profession terminal 21 (step S202).

Further, if the communication unit 160 of the lifestyle disease prevention apparatus 1 receives the target value from the medical profession terminal 21, the target value registration unit 155 stores the input target value in connection with the test subject identification information in the target value storing unit 105 as the target value is input from the medical profession terminal 21 (step S203).

The notification unit 156 notifies, in the case where the advice registration unit 154 registers the advice in connection with the test subject identification information in the advice storing unit 111 in step S202, or in the case where the target value registration unit 155 registers the target value of the biological information in connection with the test subject identification information in step S203, the test subject terminal 22 used by the test subject of information indicating that the advice is registered in the advice storing unit 111 or information indicating that the target value is registered in the target value storing unit 105, as notification information (step S204).

Accordingly, the test subject using the test subject terminal 22 may recognize that the advice or the target value for the test subject is registered by the medical profession.

<Operation 3: in the Case where the Test Subject Views the Advice or Target Value from the Medical Profession>

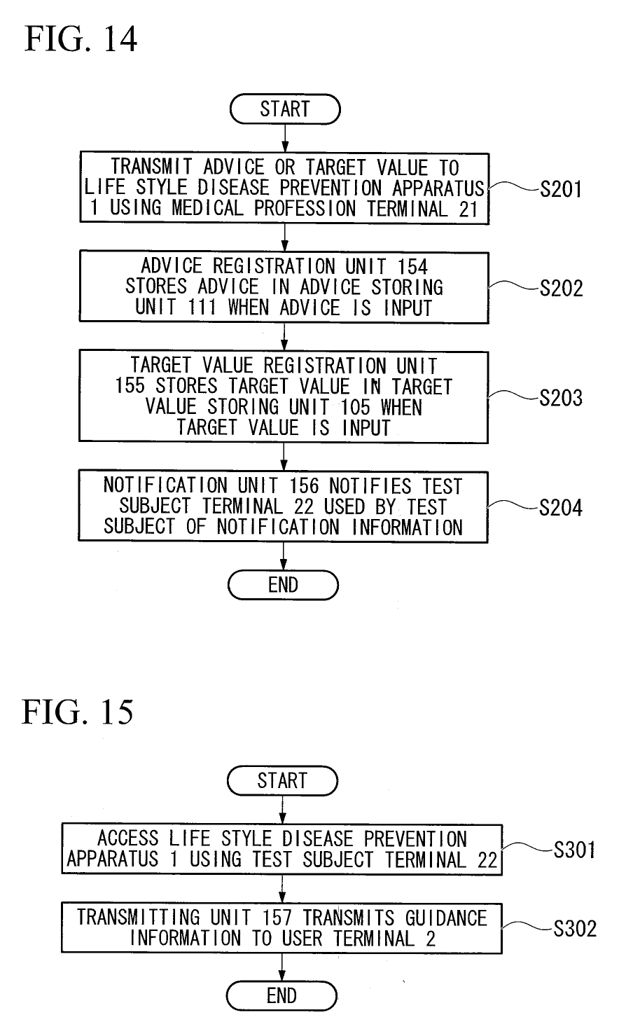

An operation of the lifestyle disease prevention apparatus 1 in the case where the test subject views the advice or target value from the medical profession will be described with reference to FIG. 15.

For example, in step S204 in FIG. 14, according to the notification from the notification unit 156 from the lifestyle disease prevention apparatus 1, if the test subject who uses the test subject terminal 22 receives the notification, that is, if it is confirmed that the advice or the target value for the test subject is registered from the medical profession, the test subject who uses the test subject terminal 22 accesses the lifestyle disease prevention apparatus 1 using the test subject terminal 22 (step S301).

In the case where the test subject identification information is received from the user terminal, the transmitting unit 157 reads the advice stored in the advice storing unit 111 in connection with the received test subject identification information, or reads the target value stored in the target value storing unit 105 in connection with the received test subject identification information, and transmits the read advice or target value to the user terminal 2 as guidance information (step S302).

In the description in FIG. 15, as the test subject who uses the test subject terminal 22 receives the notification, the test subject accesses the lifestyle disease prevention apparatus 1 using the test subject terminal 22, but the test subject who uses the test subject terminal 22 may access the lifestyle disease prevention apparatus 1 using the test subject terminal 22 at an arbitrary timing to view the advice or the target value.

As the test subject who uses the test subject terminal 22 receives the notification, the test subject accesses the lifestyle disease prevention apparatus 1 using the test subject terminal 22, to thereby view the advice or the target value at an early timing and perform early prevention and/or improvement.

However, generally, in order to provide a sufficient motivation and support for prevention and/or improvement of the lifestyle disease, an overall approach according to health improvement management and a healthcare guidance performed by the medical team should be provided for the test subject.

In order to perform such an overall approach, dealers, medical professions and healthcare insurers who provide information such as an examination result of the risk factor value should smoothly share the information and effectively use the information.

Thus, a lifestyle disease prevention system (hereinafter, referred to as the present system) using the lifestyle disease prevention apparatus 1 according to the above described embodiment may be accessed through the Internet. To this end, related organizations may access and obtain statistic information or the like of data stored in a database. Further, sufficient information for conducting healthcare guidance is provided for the medical professions, statistic data or the like on a health state of an insured person is provided for the medical insurer, to thereby provide information which is useful for the health improvement management. In addition, since the test subject may access the information or the like, sufficient information for motivating self-recognition and consciousness change for the lifestyle disease of the test subject may be provided.

As the healthcare guidance of the test subject performed by the medical professions, a made to order method based on guidance based on psychology or scientific evidence may be effectively used. The guidance based on the psychology mainly depends on the skills of the medical professions who perform the medical guidance. For this reason, in this present system, the made to order method based on scientific evidence is introduced to the healthcare guidance. The made to order method based on the scientific evidences includes classifying examination item values by different classes on the basis of statistics or classifying physical dispositions by different classes using genetic information to perform individual guidance for each class.

Further, by using genes for medical examinations, accumulation and analysis of genetic data is performed, to thereby use genetic risk factor items for the medical examination.

In addition, a new useful biomarker other than genes may be obtained by future research. Accordingly, the present system may be applied to the case where the test subject or the medical insurer performs usage determination of examinations of the risk factor items as genes or new biomarkers. More specifically, the biological information storing unit 103 capable of storing a variety of biological information in a relational database form is provided, to thereby store information for use in a clinical study of the risk factor item.

Moreover, in the case of the healthcare guidance, sufficient motivation and support should be provided for the test subject, but this increases the workload to the medical professions. Thus, the present system classifies the recognition results of diseases into patterns by stages, stores information such as changeable action plans and advice for lifestyle disease prevention to be performed by a community such as a doctor, health nurse, nutrition manager, counselor or the like in advance for each pattern, and outputs a report on the basis of diagnosis patterns, to thereby lower the workload of the medical care team.

The above described storing unit of the test subject information storing unit 101, the diagnosis result information storing unit 102, the biological information storing unit 103, the determination parameter storing unit 104, the target value storing unit 105, the comment pattern storing unit 110, the advice storing unit 111, the specific disease determination condition storing unit 112 or the authentication information storing unit 113 may be configured by a non-volatile memory such as a hard disc device, magneto-optical disc device, flash memory or the like, a read-only storage medium such as a CD-ROM or the like, a volatile memory such as a RAM (random access memory) or the like, or a combination thereof.

Further, in FIG. 1, each processing unit of the risk calculating unit 150, the report generating unit 151, the graph display unit 152, the changing unit 153, the advice registration unit 154, the target value registration unit 155, the notification unit 156, the transmitting unit 157, the specific disease determination unit 158, the communication unit 160 or the authentication unit 162 may be realized by exclusive hardware. In addition, each processing unit may be configured by a memory and a CPU (central processing unit), and may load a program for realizing functions of each processing unit in the memory and execute the program to realize the functions.

In addition, the program for realizing the functions of each processing unit in FIG. 1 may be recorded in a computer-readable recording medium so that the program recorded in the recording medium can be read and executed in a computer system, to thereby realize the functions of each processing unit. Herein, the “computer system” includes hardware such as an OS or peripheral device.

Moreover, in the case where the “computer system” uses the WWW system, the computer system further includes homepage providing environments (or display environments).

Further, the “computer-readable recording medium” includes a transportable medium such as a flexible disc, magneto-optical disc, ROM or CD-ROM, and a storing device such as a hard disc built in the computer system. In addition, the “computer-readable recording medium” includes a recording medium which temporally and dynamically stores programs, such as a communication line in the case where the programs are transmitted through the communication line such as the Internet network or telephone links, or a recording medium which stores the programs for a certain period of time, such as a volatile memory in a computer system which is a server or a client in such a case. In addition, the programs may realize a part of the above described functions, and may realize the above described functions in cooperation with programs pre-recorded in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A lifestyle disease prevention apparatus comprising:
a biological information storing unit in which biological information of a test subject in connection with test subject identification information which identifies the test subject is stored in advance; and
a risk calculating unit which reads the biological information in connection with the selected test subject identification information from the biological information storing unit and calculates a lifestyle disease probability that the test subject belongs to a progress stage for each disease targeted for prevention and/or improvement which is preset on the basis of the read biological information.

2. The lifestyle disease prevention apparatus according to claim 1, wherein the biological information of the test subject includes genetic information of the test subject, and the risk calculating unit calculates the lifestyle disease probability on the basis of the genetic information of the test subject included in the biological information of the test subject.

3. The lifestyle disease prevention apparatus according to claim 1, further comprising:
a comment pattern storing unit in which a comment for the disease targeted for prevention and/or improvement in connection with a value of the lifestyle disease probability is stored in advance of each disease targeted for prevention and/or improvement; and
a report generating unit which reads the comment corresponding to the value of the lifestyle disease probability of each disease targeted for prevention and/or improvement calculated by the risk calculating unit from the comment pattern storing unit of each disease targeted for prevention and/or improvement, combines the read comments of each disease targeted for prevention and/or improvement to generate a report.

4. The lifestyle disease prevention apparatus according to claim 1, further comprising:
an advice storing unit in which advice for the test subject is stored in connection with the test subject identification information; and
an advice registration unit in which the advice based on the lifestyle disease probability calculated by the risk calculating unit is input, and which stores the input advice in connection with the test subject identification information in the advice storing unit.

5. The lifestyle disease prevention apparatus according to claim 1, further comprising:
a target value storing unit in which a target value of the biological information about the test subject is stored in connection with the test subject identification information; and
a target value registration unit in which the target value based on the lifestyle disease probability calculated by the risk calculating unit is input, and which stores the input target value in connection with the test subject identification information in the target value storing unit.

6. The lifestyle disease prevention apparatus according to claim 1, further comprising:
a graph display unit which displays the lifestyle disease probability of each disease targeted for prevention and/or improvement calculated by the risk calculating unit in a graph form.

7. The lifestyle disease prevention apparatus according to claim 6, wherein the graph display unit displays the lifestyle disease probability of each disease targeted for prevention and/or improvement calculated by the risk calculating unit in the graph form, and displays the lifestyle disease probability of each disease targeted for prevention and/or improvement which is calculated on the basis of the target value of the biological information stored in the target value storing unit in the graph form.

8. The lifestyle disease prevention apparatus according to claim 6, further comprising:
a changing unit which changes the value of the biological information which is the biological information read from the biological information storing unit and is used in the case where the lifestyle disease probability is calculated in the risk calculating unit,
wherein the graph display unit displays the lifestyle disease probability of each disease targeted for prevention and/or improvement calculated by the risk calculating unit in the graph form, and displays the lifestyle disease probability of each disease targeted for prevention and/or improvement which is calculated on the basis of the value of the biological information changed by the changing unit in the graph form.

9. The lifestyle disease prevention apparatus according to claims 1 further comprising a discrimination parameter storing unit in which a coefficient multiplied by the biological information stored in the biological information storing unit is stored in advance for each disease targeted for prevention and/or improvement,
wherein the risk calculating unit multiplies the biological information read from the biological information storing unit by the coefficient read from the discrimination parameter storing unit to calculate a determination value of each disease targeted for prevention and/or improvement, and calculates the lifestyle disease probability that the test subject belongs to the progress stage of each disease targeted for prevention and/or improvement on the basis of the calculated determination value of each disease targeted for prevention and/or improvement.

10. A lifestyle disease prevention method for performing a lifestyle disease probability calculating procedure in a computer as a lifestyle disease prevention apparatus, the procedure comprising:
reading biological information in connection with selected test subject identification information from a biological information storing unit in which the biological information of the test subject in connection with the test subject identification information which identifies the test subject is stored in advance; and
calculating using a microprocessor, a lifestyle disease probability that the test subject belongs to a progress stage of each disease targeted for prevention and/or improvement which is preset on the basis of the read biological information.
